(19) United States
(12) Patent Application Publication
(10) Pub. No.: US 2012/0235425 A1
(43) Pub. Date: Sep. 20, 2012

(54) PIN LATCH HAVING AN INTERMEDIATE POSITION

(76) Inventor: THAI DO, Laguna Niguel, CA (US)

(21) Appl. No.: 13/416,080

(22) Filed: Mar. 9, 2012

Related U.S. Application Data
(60) Provisional application No. 61/452,717, filed on Mar. 15, 2011.
(60) Provisional application No. 61/485,317, filed on May 12, 2011.

(51) Int. Cl. E05C 1/10

(52) U.S. Cl. 292/150

(57) ABSTRACT

A pin latch includes a housing, a handle attached to the housing, a shear pin attached to the handle, and a finger member attached to the handle and the shear pin. The handle may be set in an intermediate position between open and closed positions. Trigger pins slidably engage slots formed within the finger member until they engage stops to retain the handle in its intermediate position. To further retract the shear pin and move the handle towards the open position, the finger member is lifted and the trigger pins disengage the stops. Alternately, the latch includes a button mechanism having a cross-pin that engages a stop formed by a slot within the shear pin to maintain the handle in its intermediate position. To further retract the shear pin and rotate the handle, the button mechanism is depressed to disengage the cross-pin from the slot of the shear pin.

### CROSS-REFERENCE TO RELATED APPLICATIONS

This application is a Section 111(a) application relating to and claiming the benefit of commonly owned, co-pending U.S. Provisional Patent Application Ser. No. 61/452,717 entitled “PIN LATCH HAVING AN INTERMEDIATE POSITION”, filed Mar. 15, 2011, the entirety of which is incorporated herein by reference, and commonly owned, co-pending U.S. Provisional Patent Application Ser. No. 61/485,317 entitled “PIN LATCH WITH AUTOMATIC INTERMEDIATE POSITION”, filed May 12, 2011, the entirety of which is incorporated herein by reference.

### FIELD OF THE INVENTION

The present invention relates to pin latches, and, more particularly, a pin latch having an intermediate position, and a pin latch having an automatic intermediate position.

### BACKGROUND OF THE INVENTION

Removable and moveable elements installed on exterior surfaces of aerospace vehicles, such as hatches, doors, access panels, engine cowlings, nacelles, and radomes employ latches. Handles mounted on the latches are used to open or close the elements. A typical pin latch has two positions: a closed position and an open position.

### SUMMARY OF THE INVENTION

In an embodiment, a pin latch, comprising a housing having at least one pin; a handle attached pivotally to the housing; a shear pin housed slidably within the housing and connected to the handle; and a finger member connected to the handle and to the housing, the finger member including at least one slot that is sized and shaped to receive slidably the at least one pin of the housing, the at least one slot including a first slot portion, a second slot portion, and a third slot portion that bridges the first and second slot portions with one another, the third slot portion forming a stop located between the first and second slot portions, wherein the handle is moveable between a closed position, in which the handle is retained releasably within the housing and the shear pin is extended from the housing, and an open position, in which the handle is retracted from the housing and the shear pin is retracted within the housing, wherein the handle is further moveable to an intermediate position, in which the handle is retained releasably in a position between its closed position and its open position, such that when the handle is moved from its closed position to its intermediate position, the at least one pin of the housing travels within the first slot portion of the finger member and engages the stop of the finger member in order to retain releasably the handle in its intermediate position, and wherein the finger member is moveable from an engaged position, in which the at least one pin of the housing engages the stop of the finger member, and a disengaged position, in which the at least one pin of the housing is disengaged from the stop and is adapted to travel within the second slot portion of the finger member so as to enable the handle to be moved from its intermediate position to its open position.

In an embodiment, the finger member includes at least one side member having a first end and a second end opposite the first end, and wherein the at least one slot of the finger member is formed within the at least one side member. In an embodiment, the at least one side member of the finger member includes a pair of side members, and the at least one pin of the housing includes a pair of pins, and wherein the slot of one of the side members is sized and shaped to receive slidably one of the pins of the housing, and the slot of the other of the side members is sized and shaped to receive slidably the other of the pins of the housing. In an embodiment, the finger member includes a grasping member that bridges the pair of side members, and wherein the grasping member facilitates the movement of the finger member from its engaged position to its disengaged position. In an embodiment, the first slot portion of the slot of one of the side members of the finger member is formed parallel to the second slot portion thereof, and the first slot portion of the other of the side members of the finger member is formed parallel to the second slot portion thereof. In an embodiment, the third slot portion of the slot of one of the side members of the finger member is positioned obliquely relative to the first and second slot portions thereof, and the third slot portion of the slot of the other of the side members of the finger member is positioned obliquely relative to the first and second slot portions thereof.

In an embodiment, the pin latch further comprises a link having a first end and a second end opposite the first end of the link, the first end of the link being attached pivotally to the handle and the second end of the link being attached to the shear pin.

In an embodiment, the handle includes a trigger that is releasably engageable with the pins of the housing when the handle is in its closed position. In an embodiment, the handle includes a block, wherein the first end of the link is attached pivotally to the block and the first ends of the side members of the finger members are attached pivotally to the block. In an embodiment, the handle includes a back spring.

In an embodiment, in the pin latch further comprises at least one finger extension spring having a first end connected to one of the side members of the finger member and a second end opposite the first end of the at least one finger extension spring connected to the link. In an embodiment, the at least one finger extension spring includes a pair of finger extension springs, one of which is connected to one of the pair of side members and to the link, and the other of which is connected to the other of the pair of side members and to the link.

In an embodiment, the housing includes a first end, a second end opposite the first end of the housing, and an aperture formed within the first end of the housing, and wherein the shear pin is sized and shaped to slide within the aperture. In an embodiment. In an embodiment, the housing includes at least one mounting bracket.

In another embodiment, a pin latch comprises a housing; a handle attached pivotally to the housing; a shear pin housed slidably within the housing and connected to the handle, the shear pin including a slot and a stop located at one end of the slot; and a button mechanism including a cross-pin, wherein the handle is moveable between a closed position, in which the handle is retained releasably within the housing, and an open position, in which the handle is retracted from the housing and the shear pin is retracted within the housing, wherein when the handle is in its closed position, the shear pin extends from the housing, and the button mechanism is in a depressed position such that the cross-pin of the button mechanism is disengaged from the slot of the shear pin, wherein the handle is further moveable to an intermediate position, in which the handle is retained releasably in a position between its closed position and its open position, wherein when the handle is moved from its closed position to its intermediate position, the button mechanism is moved from its depressed position to a raised position, and the shear pin retracts into the housing such that the cross-pin of the button mechanism engages the slot of the shear pin and glides therein until the cross-pin engages the stop of the shear pin. In an embodiment, the handle is moveable from its intermediate position to its closed position by depressing the button mechanism into its depressed position so as to disengage the cross-pin of the button mechanism from the slot of the shear pin.

In an embodiment, the pin latch further comprises a link having a first end and a second end opposite the first end of the link, the first end of the link being attached pivotally to the handle and the second end of the link being attached to the shear pin. In an embodiment, the housing includes at least one trigger pin and the handle includes a trigger that is releasably engageable with the at least one trigger pin of the housing when the handle is in its closed position. In an embodiment, the handle includes a block, wherein the first end of the link is attached pivotally to the block. In an embodiment, the handle includes a back spring.

In an embodiment, the housing includes a first end, a second end opposite the first end of the housing, an upper end, a lower end, and a first slot positioned proximate to the lower end, wherein the cross-pin of the button mechanism is housed movably within the first slot, and wherein the cross-pin travels within the slot when the button mechanism is moved between its depressed position and its raised position. In an embodiment, the button mechanism includes a spring to facilitate movement of the button mechanism from its depressed position to its raised position. In an embodiment, the handle engages the button mechanism and maintains it in its depressed position when the handle is in its closed position.

In an embodiment, the pin latch further comprises a plunger mechanism housed within the housing, the plunger mechanism including a plunger having a first end, a second end opposite the first end of the plunger, an interior portion extending from the second end of the plunger, a stop pin positioned proximate to the first end of the plunger, and a spring housed within the interior portion of the plunger, and wherein the housing includes a second slot extending longitudinally between the first and second ends of the housing and including a first end and a second end opposite the first end of the second slot, wherein the stop pin of the plunger is sized and shaped to engage and travel within the second slot of the housing. In an embodiment, when the handle is moved from its intermediate position to its open position, the second end of the shear pin urges the plunger towards the second end of the housing and the stop pin of the plunger to travel within the second slot of the housing until the stop pin stops at the second end of the second slot, and the spring of the plunger mechanism is maintained in a compressed state.

In an embodiment, the handle is adapted to be manually held in its open position, and wherein when the handle is manually released, the spring of the plunger mechanism expands from its compressed state to an expanded state, thereby urging the plunger to extract the shear pin until the stop pin stops against the first end of the second slot of the housing, and the cross-pin engages the slot of the shear pin.

In an embodiment, the housing includes an aperture formed within the first end of the housing, and wherein the shear pin is sized and shaped to slide within the aperture. In an embodiment, the housing includes at least one mounting bracket.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a top perspective view of a pin latch constructed in accordance with an embodiment of the present invention, the pin latch being shown in a closed position;

FIG. 2 is a partial, cross-sectional side view of the pin latch shown in FIG. 1, with portions thereof being shown transparent for the purposes of clarity;

FIGS. 3A and 3B are top perspective and top plan views, respectively, of a housing employed by the pin latch shown in FIG. 1;

FIG. 4 is a top perspective view of a handle employed by the pin latch shown in FIG. 1;

FIG. 5 is a top perspective view of the pin latch shown in FIG. 1, the pin latch being shown in an intermediate position, and with portions thereof being shown transparent for the purposes of clarity;

FIG. 6 is a partial, cross-sectional side view of the pin latch shown in FIG. 5, with portions thereof being shown transparent for the purposes of clarity;

FIGS. 7A through 7C show perspective, front elevational, and side elevational views, respectively, of a block employed by the pin latch shown in FIGS. 1 and 5;

FIGS. 8A through 8D show perspective, top plan, front elevational, and side elevational views, respectively, of a finger member employed by the pin latch shown in FIGS. 1 and 5;

FIG. 9 is a top perspective view of the pin latch shown in FIG. 1, the pin latch being shown in an open position;

FIG. 10 is a partial, cross-sectional side view of the pin latch shown in FIG. 9, with portions thereof being shown transparent for the purposes of clarity;

FIG. 11 is a top perspective view of a pin latch constructed in accordance with another embodiment of the present invention, the pin latch being shown in a closed position;

FIG. 12 is a partial, cross-sectional side view of the pin latch shown in FIG. 11;

FIGS. 13A through 13G show top and bottom perspective, top plan, side, front and rear elevational, and bottom plan views of a housing employed by the pin latch shown in FIG. 11;

FIGS. 14A and 14B are top and bottom perspective views, respectively, of a handle employed by the pin latch shown in FIG. 11;

FIG. 15 is a top perspective view of the pin latch shown in FIG. 11, the pin latch being shown in an intermediate position;

FIG. 16 is a cross-sectional side view of the pin latch shown in FIG. 15;

FIGS. 17A and 17B show perspective and rear elevational views, respectively, of a block employed by the pin latch shown in FIGS. 11 and 15;

FIGS. 18A through 18D show top perspective, top plan, side elevational, and rear elevational views, respectively, of a shear pin employed by the pin latch shown in FIGS. 11 and 15;

FIGS. 19A through 19E show top perspective, top plan, side elevational, and rear and front elevational views, respectively, of a plunger employed by the pin latch shown in FIGS. 11 and 15;

FIGS. 20A through 20E show top perspective, top plan, front elevational, side elevational, and bottom plan views, respectively, of a button employed by the pin latch shown in FIGS. 11 and 15;

FIG. 21 is a top perspective view of the pin latch shown in FIG. 11, the pin latch being shown in an open position; and

FIG. 22 is a cross-sectional side view of the pin latch shown in FIG. 21.

### DETAILED DESCRIPTION OF THE DRAWINGS

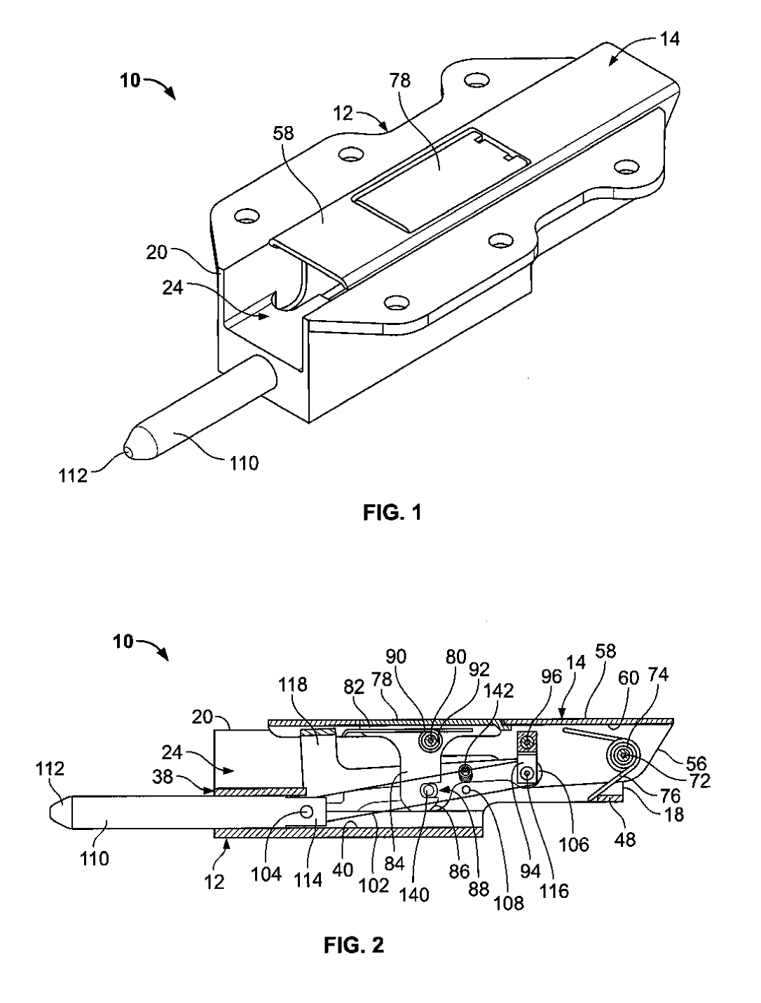

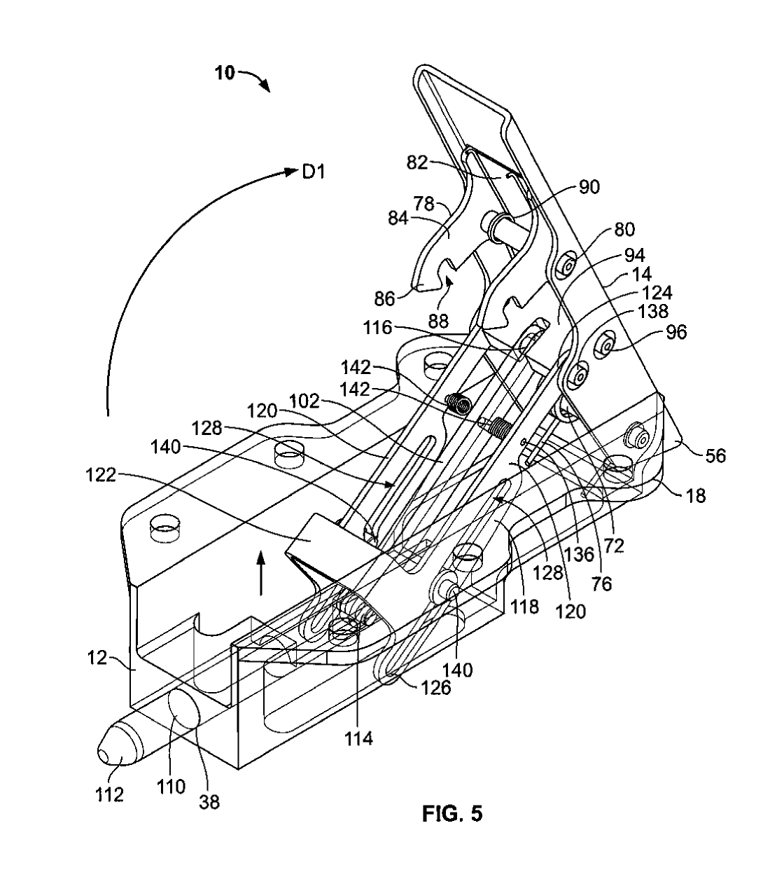

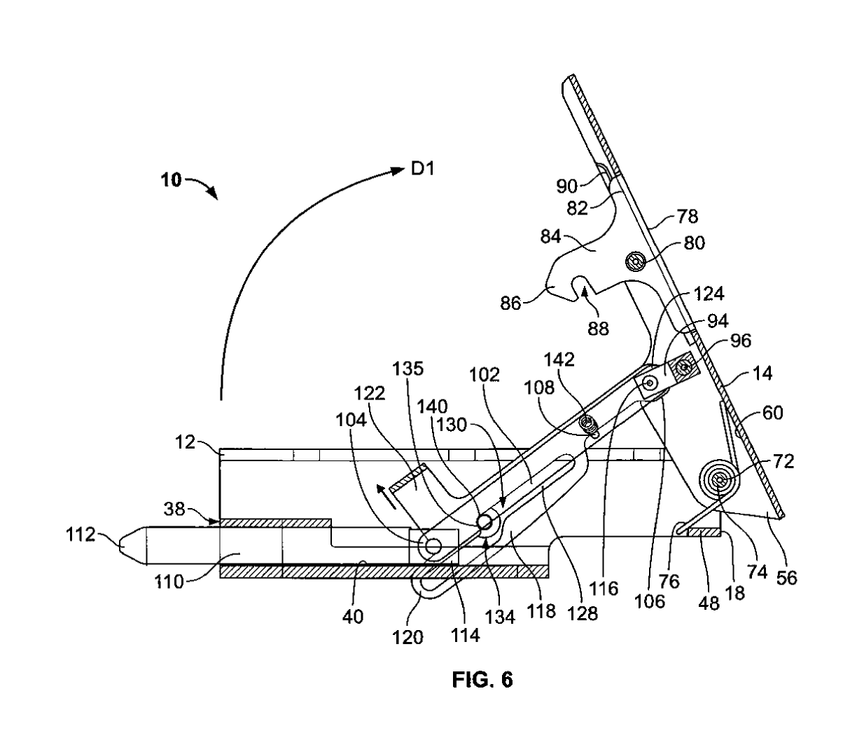

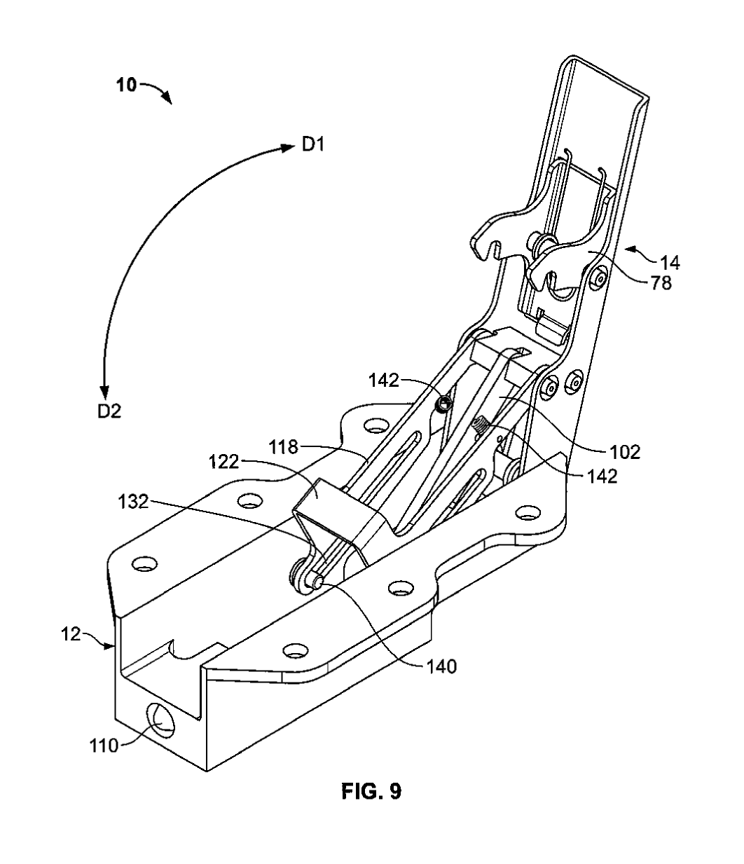

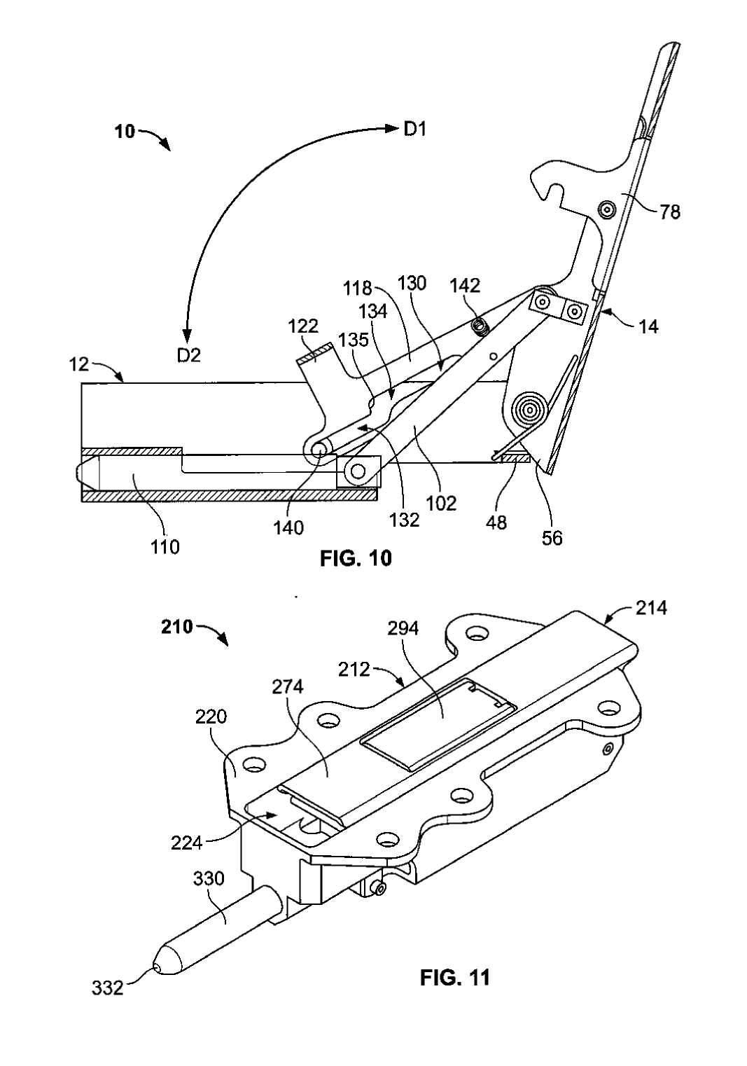

Referring to FIGS. 1 and 2, in an embodiment, a pin latch 10 includes a housing 12 and a handle 14 attached pivotally to the housing 12. In an embodiment, the handle 14 pivots relative to the housing 12 between a closed position, in which the handle 14 is releasably retained within the housing 12 (see FIGS. 1 and 2), and an open position, in which the handle 14 fully extends from the housing 12 (see FIGS. 9 and 10). In an embodiment, the handle 14 may be set in an intermediate position, whereby the handle 14 is releasably retained in a position that is between its open and closed positions (see FIGS. 5 and 6). The structure and function of the housing 12 and the handle 14 shall be described in further detail.

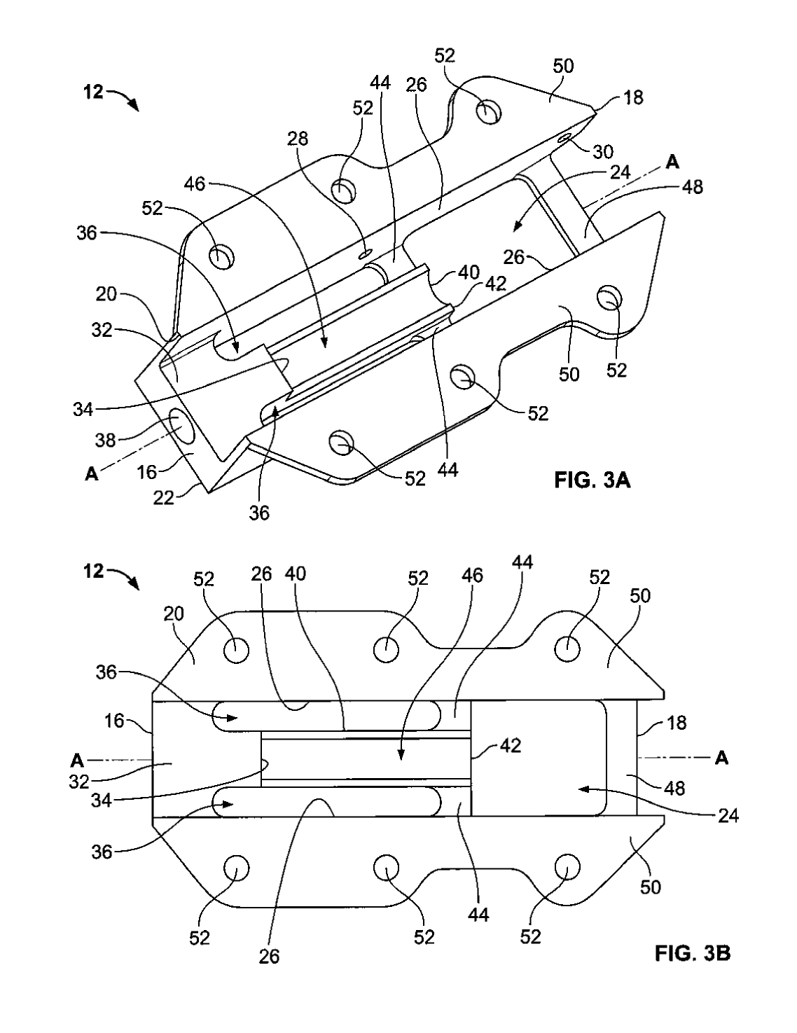

Referring to FIGS. 3A and 3B, the housing 12 includes a first end 16 a second end 18 opposite the first end 16, an upper end 20, and a lower end 22 opposite the upper end 20. In an embodiment, a channel 24 extends from the first end 16 to the second end 18, and is disposed between a pair of sidewalls 26. In an embodiment, each of the sidewalls 26 includes an aperture 28 positioned intermediate the first and second ends 16, 18, and another aperture 30 positioned proximate to the second end 18 (only the apertures 28, 30 of one of the sidewalls 26 being shown in FIG. 3A). In an embodiment, a block portion 32 defines a portion of the channel 24 and extends from the first end 16 to an end 34. In an embodiment, the block portion 32 includes slots 36 formed adjacent the sidewalls 26. In an embodiment, the block portion 32 includes an aperture 38 (see FIG. 3A) that extends from the first end 16 to the end 34 along a longitudinal axis A-A. In an embodiment, a semi-tubular-shaped trough 40 extends from the end 34 of block portion 32 to an end 42 intermediate the first and second ends 16, 18. In an embodiment, the trough 40 is integrally connected with the end 34 of the block portion 32. In an embodiment, the end 42 of the trough 40 is connected to the sidewalls 26 by a pair of spans 44. In an embodiment, the trough 40 has an interior portion 46 that is aligned with the aperture 38. In an embodiment, a crossbar 48 extends between the sidewalls 26 proximate to the second end 18.

Still referring to FIGS. 3A and 3B, in an embodiment, a pair of mounting brackets 50 extends outwardly from the upper end 20 of the housing 12 perpendicular to the sidewalls 26, and longitudinally from the first and second ends 14, 16. In an embodiment, the mounting brackets 50 enable the pin latch 10 to be mounted to an external structure. In this regard, and in an embodiment, each of the brackets 50 includes a plurality of apertures 52 that are sized and shaped to receive mounting hardware, such as fasteners (e.g., bolts, screws, rivets, etc.), for fastening the pin latch 10 to the external structure (not shown in the Figures).

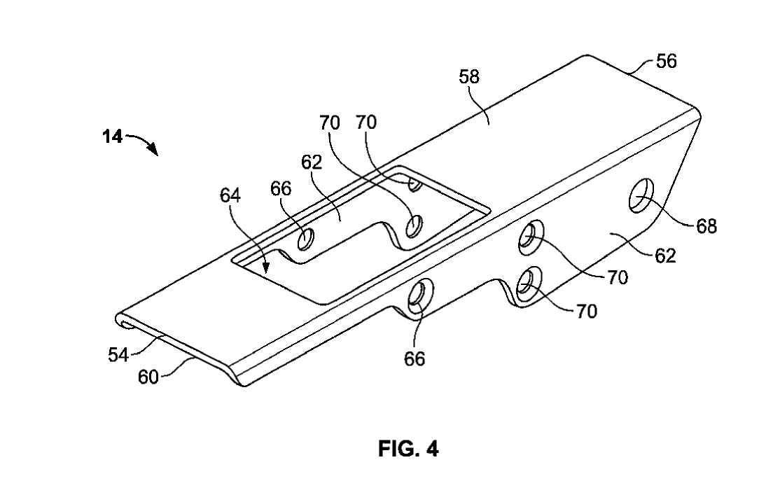

Referring to FIG. 4, in an embodiment, the handle 14 includes a first end 54 and a second end 56 opposite the first end 54, an exterior surface 58, an interior surface 60, and opposing side members 62. In an embodiment, the handle 14 includes a rectangular-shaped aperture 64 extending from the exterior surface 58 to the interior surface 60. In an embodiment, each of the opposing side members 62 includes a trigger pin aperture 66 positioned at one end thereof, a pivot pin aperture 68 positioned at an opposite end thereof (only one of which is shown in FIG. 4), and a pair of apertures 70 positioned intermediate the apertures 66, 68.

Referring to FIGS. 2 and 5-6, in an embodiment, the second end 56 of the handle 14 is attached pivotally to the second end 18 of the housing 12 by a handle pivot pin 72 that extends through the apertures 68 of the opposing side members 62 (the apertures 68 being shown in FIG. 4). In an embodiment, the handle pivot pin 72 includes bushings 74. In an embodiment, a back spring 76 surrounds the handle pivot pin 72 and engages the crossbar 48 of the housing 12 and the interior surface 60 of the handle 14 in order to maintain it in its intermediate and open positions, which will be described in greater detail below.

Still referring to FIGS. 2, 5 and 6, in an embodiment, the handle 14 includes a trigger 78 mounted pivotally therein by a pair of trigger pivot pins 80, which are fitted within the first apertures 66 of the opposing side members 62 (the first apertures 66 being shown in FIG. 4). In an ‘embodiment, the trigger 78 includes a rectangular-shaped top portion 82 that is sized and shaped to mate with the aperture 64 of the handle 14 (the aperture 64 being shown in FIG. 4), and a pair of opposing detents 84, each having a cupped tip 86 and a slot 88, and depending from the top portion 82 of the trigger 78. In an embodiment, the trigger 78 includes a trigger spring 90 mounted to the trigger pivot pins 80 by trigger bushings 92 (see FIG. 2).

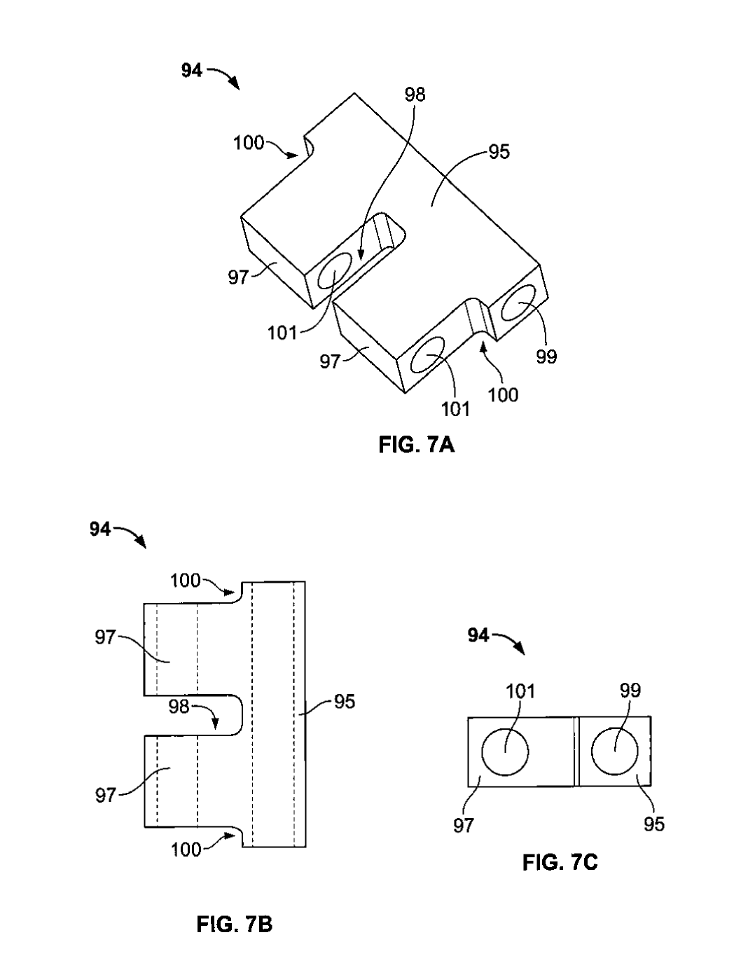

Still referring to FIGS. 2, 5 and 6, in an embodiment, the handle 14 includes a block 94 mounted between the opposing side members 62 thereof by rivets 96, which are received by the apertures 70 of the handle 14 (the apertures 70 being shown in FIG. 4). Referring to FIGS. 7A through 7C, in an embodiment, the block 94 includes a base portion 95 and two legs 97 extending from the base portion 95 and separated by a central slot 98. In an embodiment, a pair of side slots 100 flank the legs 97. In an embodiment, the base portion 95 includes an aperture 99 extending therethrough, and each of the legs 97 include an aperture 101 extending therethrough, respectively.

Referring back to FIGS. 2 and 5-6, in an embodiment, the pin latch 10 includes an elongated link 102 having a first end 104, a second end 106 opposite the first end 104, and an aperture 108 positioned intermediate the first and second ends 102, 104. In an embodiment, the pin latch 10 includes a shear pin 110 having a free first end 112 and a second end 114 opposite the first end 112. In an embodiment, the first end 104 of the link 102 is received within the central slot 98 of the block 94 (the central slot 98 being shown in FIGS. 7A and 7B) and is attached pivotally to the block 94 by a central pivot pin 116. In an embodiment, the second end 106 of the link 102 is attached pivotally to the second end 114 of the shear pin 110. In an embodiment, the shear pin 110 is received slidably within the trough 40 and the aperture 38 of the housing 12. In an embodiment, the pin latch 10 includes a finger member 118 attached pivotally to the housing 12 and the handle 14. The finger member 118 is described hereinbelow.

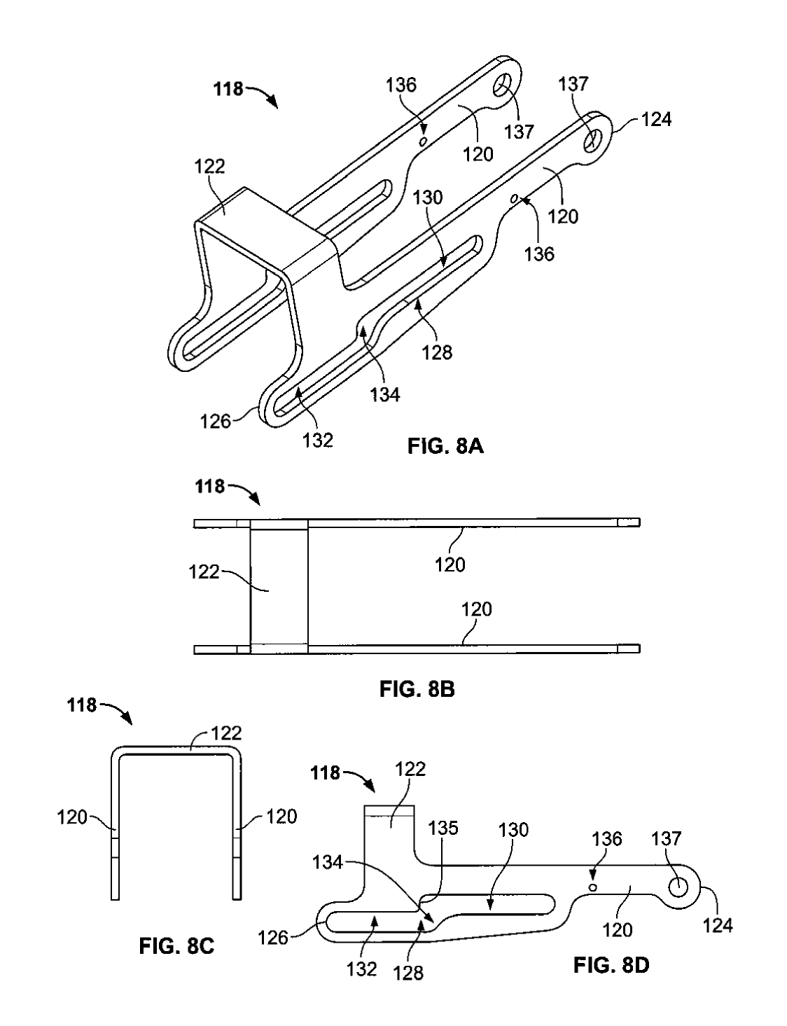

Referring to FIGS. 8A through 8D, in an embodiment, the finger member 118 includes a pair of opposed elongated side members 120 bridged by a U-shaped grasping member 122. In an embodiment, each of the side members 120 includes a first end 124 and a second end 126 opposite the first end 124, and a Z-shaped slot 128. In an embodiment, each of the slots 128 is characterized by a first, upper slot portion 130, a second, lower slot portion 132, and a third slot portion 134 that connects the first upper and second, lower slot portions 130, 132 and forms a stop 135 (see FIG. 8D). In an embodiment, the third slot portion 134 is formed oblique relative to the slot portions 130, 132. In an embodiment, the slot portions 130, 132 are parallel to one another. In an embodiment, each of the side members 120 includes an aperture 136 positioned intermediate the first and second ends 124, 126. Each of the first ends 124 of the side member 120 include an aperture 137.

Referring back to FIGS. 2 and 5-6, in an embodiment, the first ends 124 of the side members 120 of the finger member 118 are received within the side slots 100 of the block 94, respectively, and are connected pivotally thereto by rivets 138 received within the apertures 68 of the handle 14 and the apertures 137 of the side members 120 of the finger member 118 (the apertures 137 being shown in FIGS. 8A and 8D). In an embodiment, each of the apertures 28 of the housing 12 (which are shown in FIG. 3A) receives a trigger pin 140. In an embodiment, the trigger pins 140 are received within the slots 128 of the side members 120. In an embodiment, first finger extension springs 142 connect each of the side members 120 with the link 102, such that one end of each of the first finger extension springs 142 is attached to the apertures 136 of the side members 120 and an opposite end of each of the springs 142 is attached to the aperture 108 of the link 102. The purpose and function of the first and second finger extension springs 142 shall be described hereinafter.

In an embodiment, the housing 12 and the handle 14 are fabricated from stainless steel, but other suitable materials can be used. In an embodiment, all other structural elements depicted in the Figures may also be fabricated from suitable grade stainless steel or other suitable alloy metals.

Referring to FIGS. 1 and 2, the pin latch 10 is shown in its closed position. While in the closed position, the handle 14 is retained within the channel 24 of the housing 12, with the exterior surface 58 of the handle 14 being flush or substantially flush with the upper end 20 of the housing 12. In an embodiment, the exterior surface 58 of the handle is flush or substantially flush with the exterior surface of the external structure to which the pin latch 10 is attached (not shown in the Figures). As shown in FIGS. 1 and 2, the shear pin 110 is in its fully extended position, i.e., the first end 112 of the shear pin 110 is positioned at a maximum distance from the housing 12. The shear pin 110 is sized and shaped to engage an external structure (not shown in the Figures). In addition, the trigger 78 engages the trigger pin 140 such that trigger pins 140 engage the slots 88 of the detents 84. In an embodiment, the trigger 78 is spring-loaded via the trigger spring 90. In an embodiment, the finger extension springs 142 are in a relaxed state: that is, a state in which the springs 142 are neither tensioned, nor compressed, nor torqued (e.g., twisted).

Referring to FIGS. 5 and 6, in an embodiment, the pin latch 10 is opened by pressing the trigger 78, wherein the tips 86 of the trigger 78 are released from the trigger pins 140, and the trigger pins 140 disengage the slots 88 of the trigger 78, freeing the handle 14 to be rotated outwardly in direction D1 from the exterior surface of the structure (not shown in the Figures). In an embodiment, when the trigger 78 is pushed, the handle 14 automatically and freely opens via the back spring 76. In an embodiment, when the handle 14 is rotated in this manner, the link 102 is pulled and, in turn, the shear pin 110 retracts into the housing 12. Simultaneously, the first ends 124 of the side members 120 of the finger member 118 pivot about the rivets 138 which are fixed in the block 94, while the trigger pins 140 guide the second ends 126 of the side members 120 via the slots 128. More particularly, in an embodiment, the trigger pins 140 glide within the first, upper slot portions 130, until they reach the third, oblique slot portions 134 and engage the stops 135, respectively. The shear pin 110 then stops and the handle 14 is retained in place in the intermediate position, as shown in FIGS. 5 and 6. Moreover, in an embodiment, the finger extension springs 142 extend and pull the side members 120 of the finger member 118 and the link 102 towards one another in a scissor-like action. In an embodiment, the springs 142 are under tension load in order to retain the handle 14 in its intermediate position. In an embodiment, in order to further retract the shear pin 110, the finger member 118 is manually lifted up by the grasping member 122 in order to disengage the trigger pins 140 from the third slot portions 134 of the finger member 118 and clear the stops 135. Referring to FIGS. 9 and 10, in an embodiment, lifting the finger member 118 in the foregoing manner allows the trigger pins 140 to engage the second, lower slot portions 132 of the finger member 118. As a result, the handle 14 may then be further rotated in direction 01 until the second end 56 of the handle 14 engages the crossbar 48 of the housing 12 (see FIG. 10). At this point, the handle 14 is in the open position and the shear pin 110 is fully retracted within the housing 12, as shown in FIGS. 9 and 10. Moreover, the finger extension springs 142 extend further and continue to remain under a tension load.

In order to close the handle 14 from the open position to the closed position, the handle 14 is rotated in an opposite direction 02 towards the closed position (see FIG. 9). In this regard, the handle 14 pushes the link 102 to extract the shear pin 110 until the trigger 78 engages the trigger pins 140 and the handle 14 is retained within the channel 24 of the housing 12 (see FIGS. 1 and 2). Simultaneously, the trigger pins 140 slide through the second, lower horizontal slot portions 132, respectively, and then through the first, upper horizontal slot portions 130, respectively, of the finger member 118. Also, the finger extension springs 142 are brought back to a relaxed state.

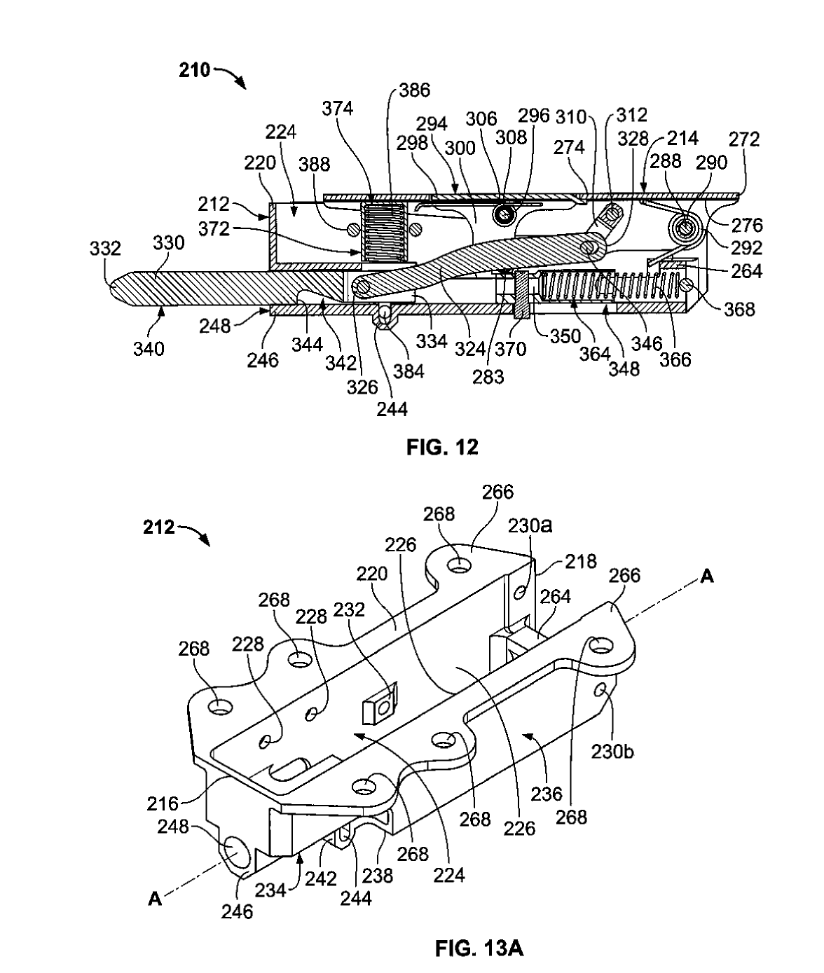

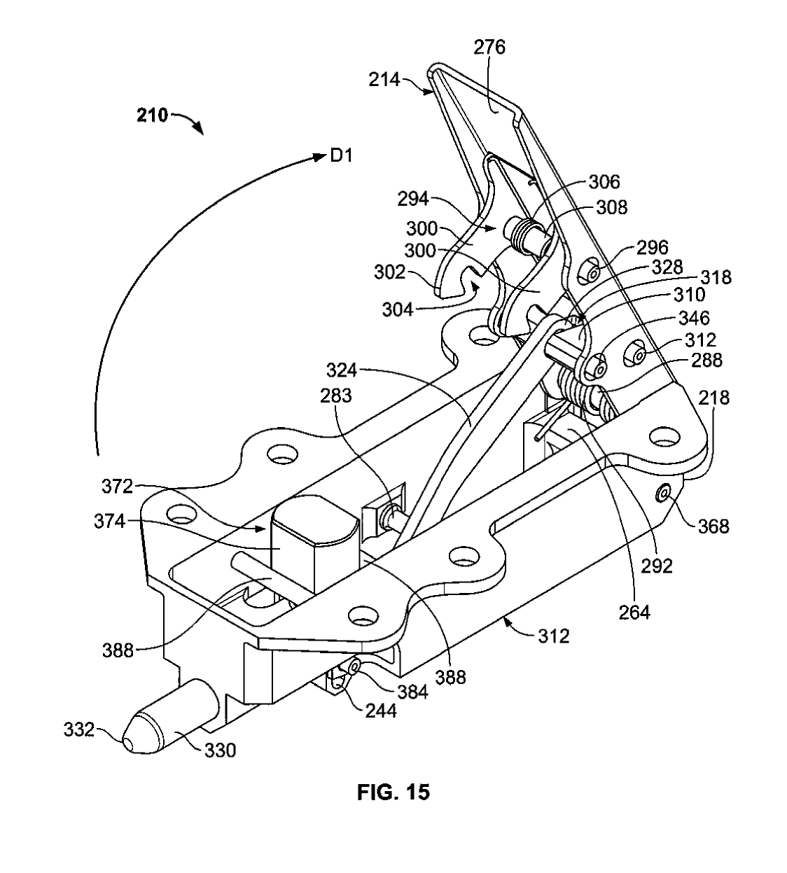

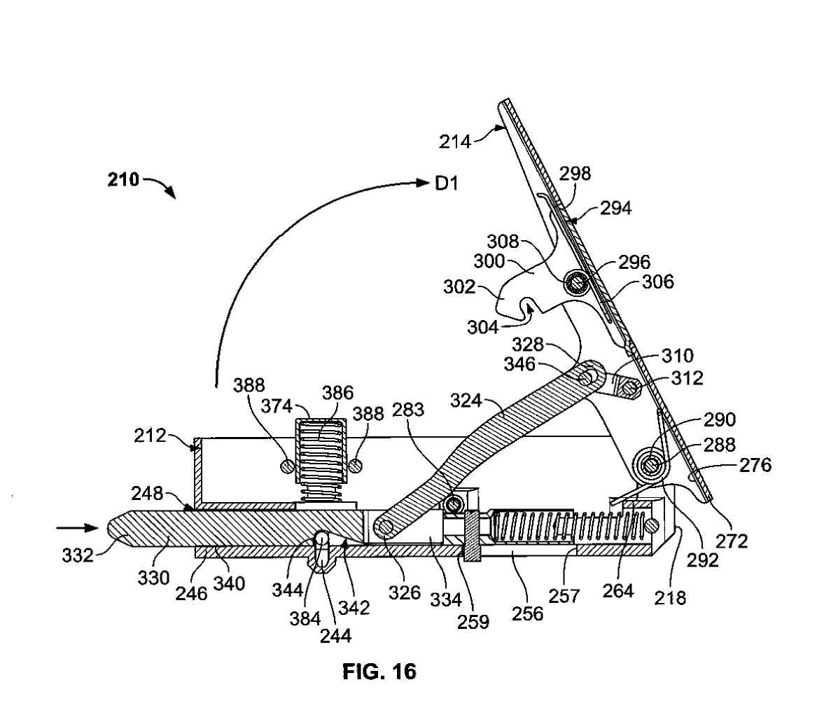

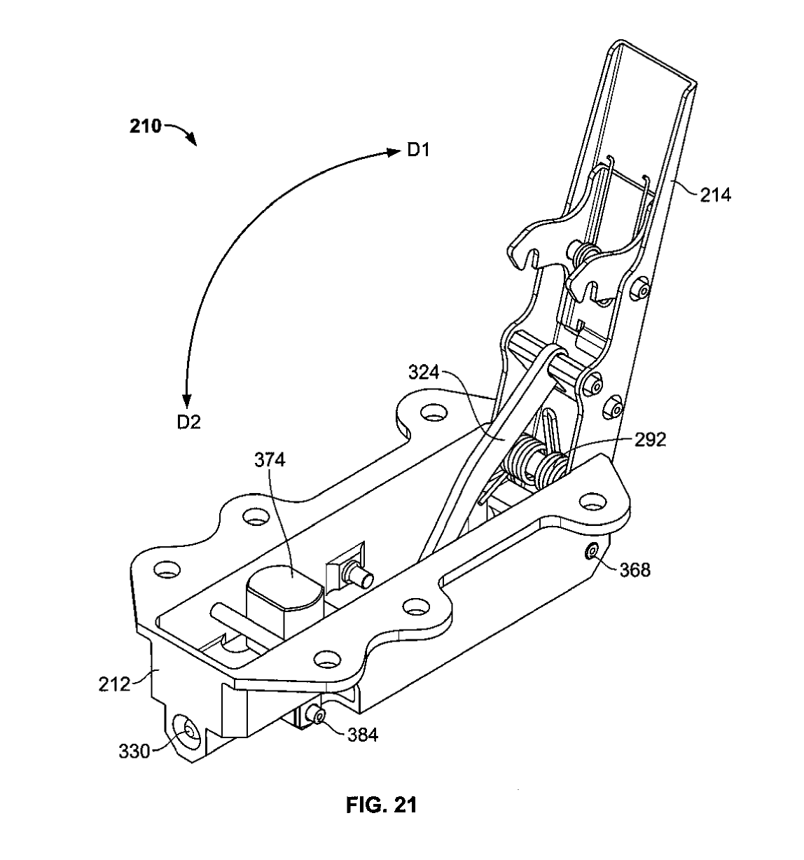

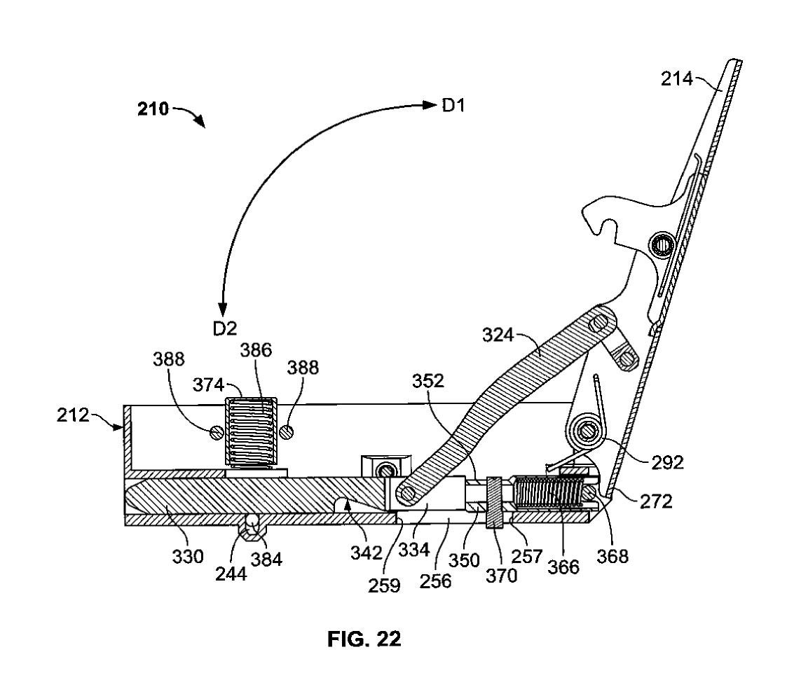

Referring to FIGS. 11 and 12, in an embodiment, a pin latch 210 includes a housing 212 and a handle 214 attached pivotally to the housing 212. In an embodiment, the handle 214 pivots relative to the housing 212 between a closed position, in which the handle 214 is releasably retained within the housing 212 (see FIGS. 11 and 12), and an open position, in which the handle 214 fully extends from the housing 212 (see FIGS. 21 and 22). In an embodiment, the handle 214 may be automatically set in an intermediate position, whereby the handle 214 is releasably retained in a position that is between its open and closed positions (see FIGS. 15 and 16). The structure and function of the housing 212 and the handle 214 shall be described in further detail.

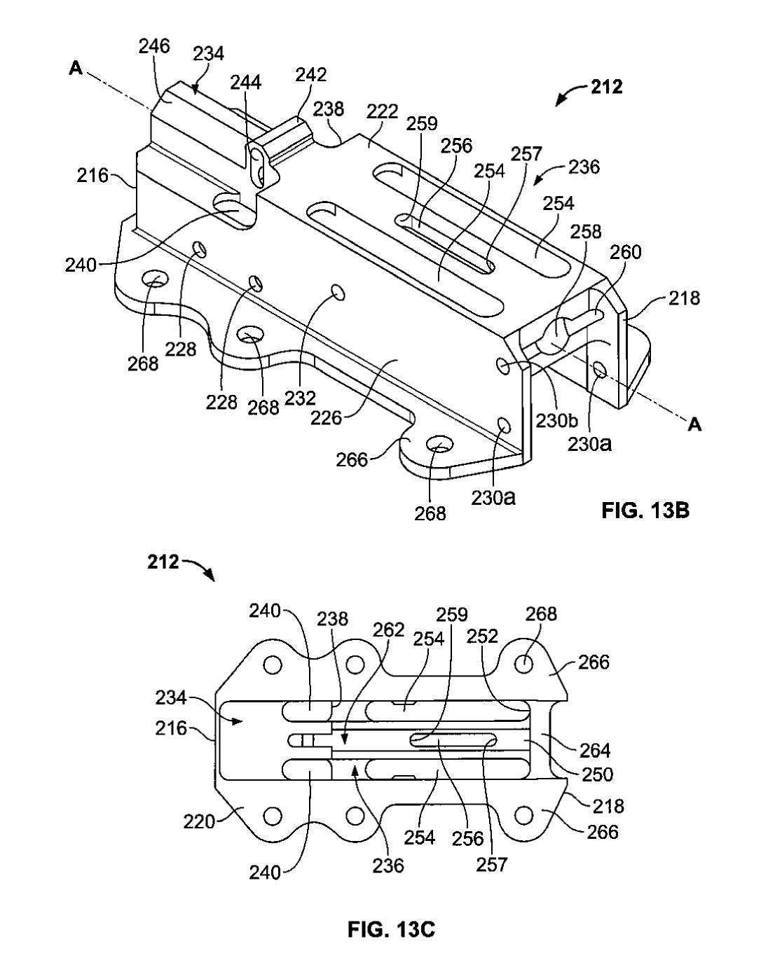

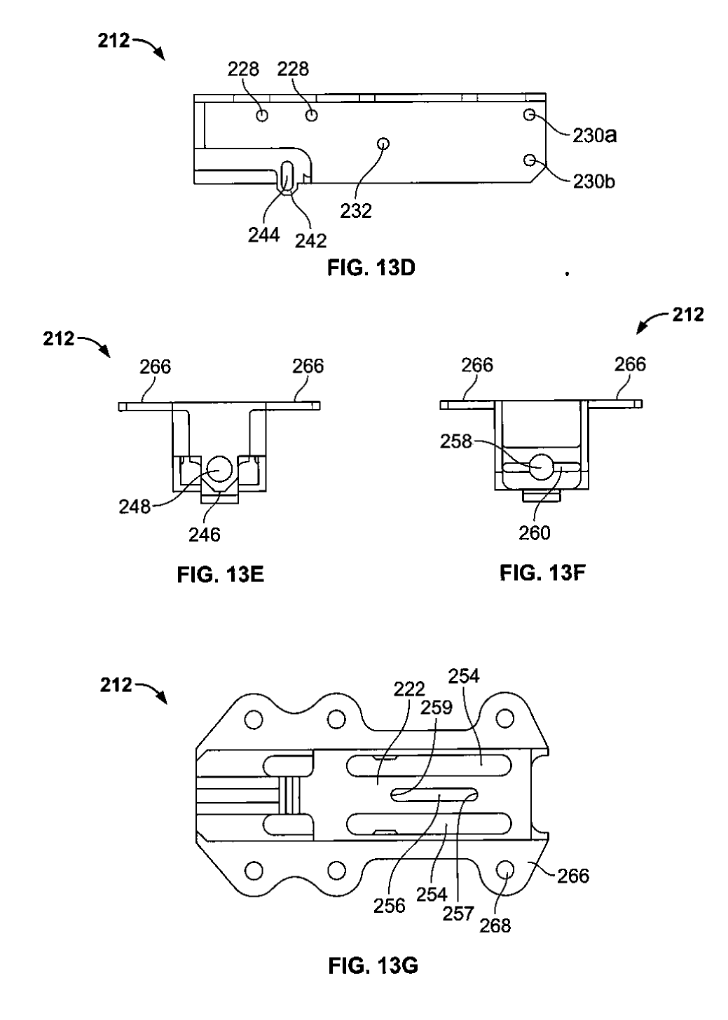

Referring to FIGS. 13A through 13G, the housing 212 includes a first end 216 a second end 218 opposite the first end 216, an upper end 220, and a lower end 222 opposite the upper end 220. In an embodiment, a channel 224 extends from the first end 216 to the second end 218, and is disposed between a pair of sidewalls 226. In an embodiment, the channel 224 is closed off at the first end 216 of the housing 212 and open at the second end 218 of the housing 212. In an embodiment, each of the sidewalls 226 includes a pair of horizontally aligned apertures 228 positioned proximate to the first end 216, a pair of apertures 230a positioned proximate to the second end 218 and the upper end 220, and an aperture 232 positioned intermediate the first and second ends 216, 218. In an embodiment, one of the sidewalls 226 includes an aperture 230b positioned proximate to the lower end 222 and spaced apart from the aperture 230a formed within such sidewall 226. In an embodiment, the housing 212 includes a first portion 234 and a second portion 236, which define the channel 224. In an embodiment, the first portion 234 extends from the first end 216 to an end 238. In an embodiment, the first portion 234 includes a pair of slots 240 formed adjacent the sidewalls 226. In an embodiment, the first portion 234 includes a cross-pin housing 242 containing an elongated slot 244, and a shear pin housing 246 containing an aperture 248 (see FIG. 13A) that extends axially from the first end 216 to the end 238 along a longitudinal axis A-A.

Still referring to FIGS. 13A through 13G, in an embodiment, the second portion 236 includes a semi-tubular-shaped trough 250 (see FIG. 13C) that extends from the end 238 of the first portion 234 to an end 252 intermediate the first and second ends 216, 218. In an embodiment, the trough 250 is integrally connected with the end 238 of the first portion 234. In an embodiment, a pair of elongated slots 254 flank the trough 250, while an elongated central slot 256 is formed in the trough 250 and positioned intermediate the slots 254. In an embodiment, the central slot 256 includes a first end 257 and a second end 259 opposite the first end 257. In an embodiment, a circular-shaped aperture 258 and an overlapping, elongated horizontal slot 260 is formed in the end 252 of the second portion 236. In an embodiment, the trough 250 has an interior portion 262 that is aligned axially with the aperture 248 of the first portion 234 and the aperture 258 of the second portion 236. In an embodiment, a crossbar 264 extends between the sidewalls 226 proximate to the second end 218.

Still referring to FIGS. 13A through 13G, in an embodiment, a pair of mounting brackets 266 extends outwardly from the upper end 220 of the housing 212 perpendicular to the sidewalls 226, and longitudinally from the first and second ends 214, 216. In an embodiment, the mounting brackets 266 enable the pin latch 210 to be mounted to an external structure. In this regard, and in an embodiment, each of the brackets 266 includes a plurality of apertures 268 that are sized and shaped to receive mounting hardware, such as fasteners (e.g., bolts, screws, rivets, etc.), for fastening the pin latch 210 to the external structure (not shown in the Figures).

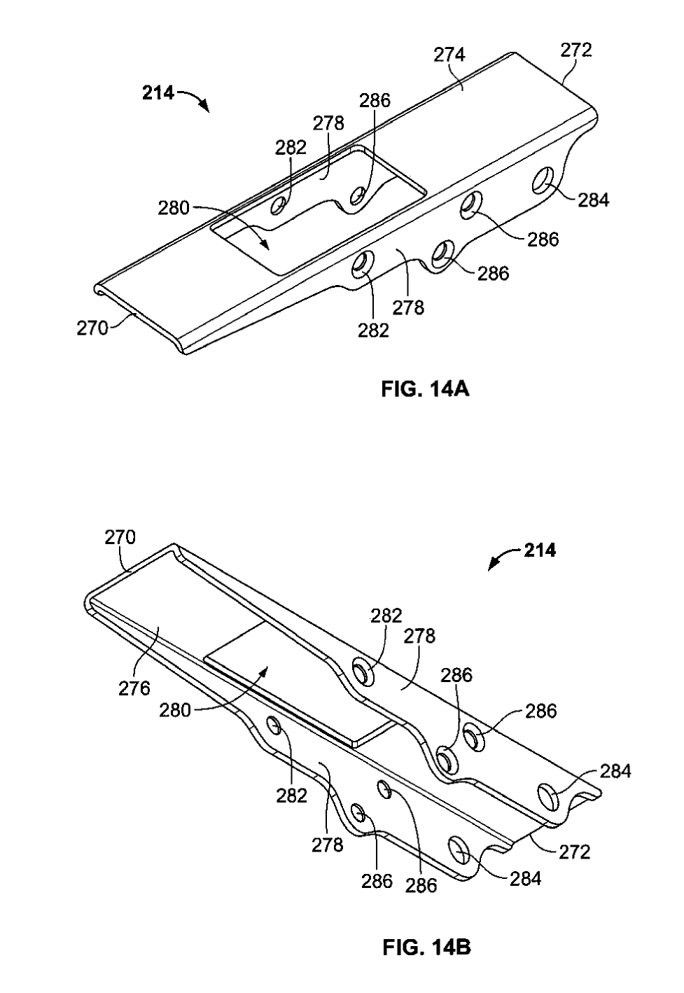

Referring to FIGS. 14A and 14B, in an embodiment, the handle 214 includes a first end 270 and a second end 272 opposite the first end 270, an exterior surface 274, an interior surface 276, and opposing side members 278. In an embodiment, the handle 214 includes a rectangular-shaped aperture 280 extending from the exterior surface 274 to the interior surface 276. In an embodiment, each of the opposing side members 278 includes a trigger pin aperture 282 positioned at one end thereof, a pivot pin aperture 284 positioned at an opposite end thereof, and a pair of mounting block apertures 286 positioned intermediate the apertures 280, 282. In an embodiment, each of the trigger pin apertures 232 of the housing 212 receives a trigger pin 283 (see FIG. 15), whose purpose shall be described hereinafter.

Referring to FIGS. 12, 15 and 16, in an embodiment, the second end 272 of the handle 214 is attached pivotally to the second end 218 of the housing 212 by a handle pivot pin 288 that extends through the pivot pin apertures 284 of the opposing side members 278 of the handle 214 (the pivot pin apertures 284 being shown in FIGS. 14A and 14B). In an embodiment, the handle pivot pin 288 includes bushings 290. In an embodiment, a back spring 292 surrounds the handle pivot pin 288 and engages the crossbar 264 of the housing 212 and the interior surface 276 of the handle 214 in order to maintain it in its intermediate and open positions, which will be described in greater detail below.

Still referring to FIGS. 12, 15 and 16, in an embodiment, the handle 214 includes a trigger 294 mounted pivotally therein by a pair of trigger pivot pins 296, which are fitted within the trigger pin apertures 282 of the opposing side members 278 of the handle 214 (the trigger pin apertures 282 being shown in FIGS. 14A and 14B). In an embodiment, the trigger 294 includes a rectangular-shaped top portion 298 that is sized and shaped to mate with the aperture 280 of the handle 214, and a pair of opposing detents 300, each having a cupped tip 302 and a slot 304 (see FIG. 15), and depending from the top portion 298 of the trigger 294. In an embodiment, the trigger 294 includes a trigger spring 306 mounted to the trigger pivot pins 296 by trigger bushings 308.

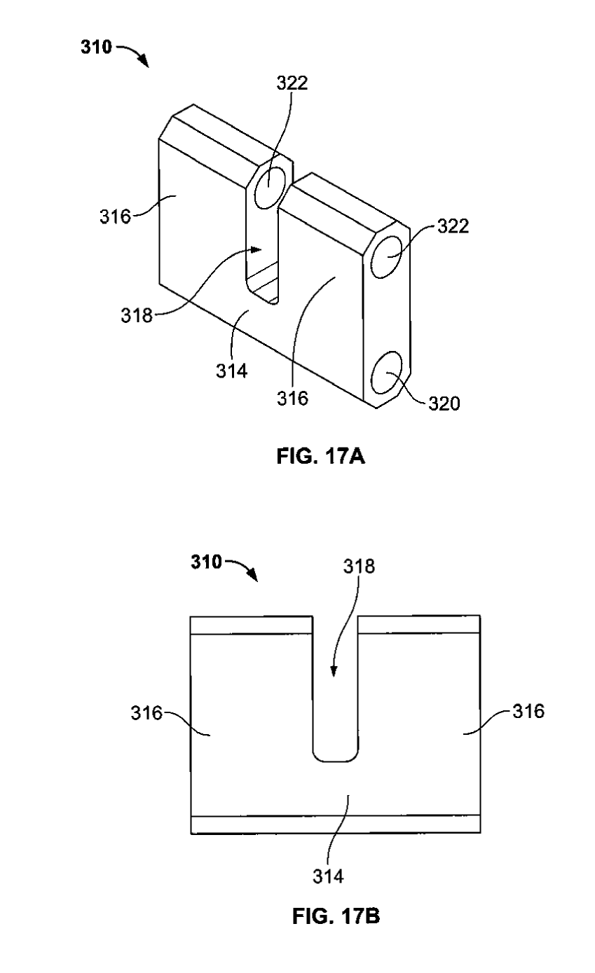

Referring to FIGS. 15 and 16, in an embodiment, the handle 214 includes a block 310 mounted between the opposing side members 278 of the handle 214 by rivets 312, which are received by the apertures 286a. Referring to FIGS. 17A and 17B, in an embodiment, the block 310 includes a base portion 314 and two legs 316 extending from the base portion 314 and separated by a central slot 318. In an embodiment, the base portion 314 includes an aperture 320 extending therethrough, and each of the legs 316 include an aperture 322 extending therethrough, respectively (see FIG. 17A).

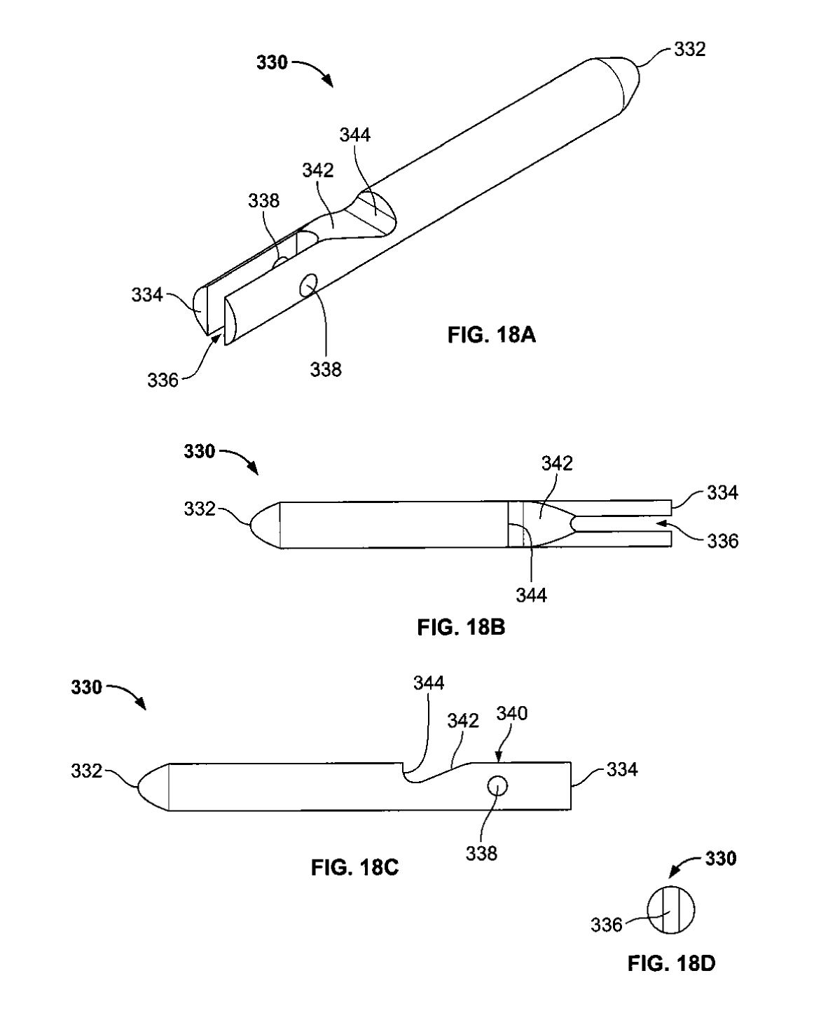

Referring back to FIGS. 15 and 16, in an embodiment, the pin latch 210 includes an elongated link 324 having a first end 326 and a second end 328 opposite the first end 326. Referring to FIGS. 15, 16, and 18A through 18D, in an embodiment, the pin latch 210 includes a shear pin 330 having a free first end 332, a second end 334 opposite the first end 332, and a first slot 336 formed axially within the second end 334. In an embodiment, each of a pair of apertures 338 is formed transversely within the shear pin 330 proximate to the second end 334. In an embodiment, a bottom edge 340 of the shear pin 330 includes a curved slot 342 terminating at a stop 344. The purpose and function of the slot 342 and the stop 344 shall be described hereinafter. Referring specifically to FIG. 15, in an embodiment, the second end 328 of the link 324 is received within the central slot 318 of the block 310 and is attached pivotally to the block 310 by a central pivot pin 346. In an embodiment, the first end 326 of the link 324 is attached pivotally to the second end 328 of the shear pin 330. In an embodiment, the shear pin 330 is received slidably within the trough 250 of the housing 212 and through the aperture 248 of the shear pin housing 246 of the housing 212.

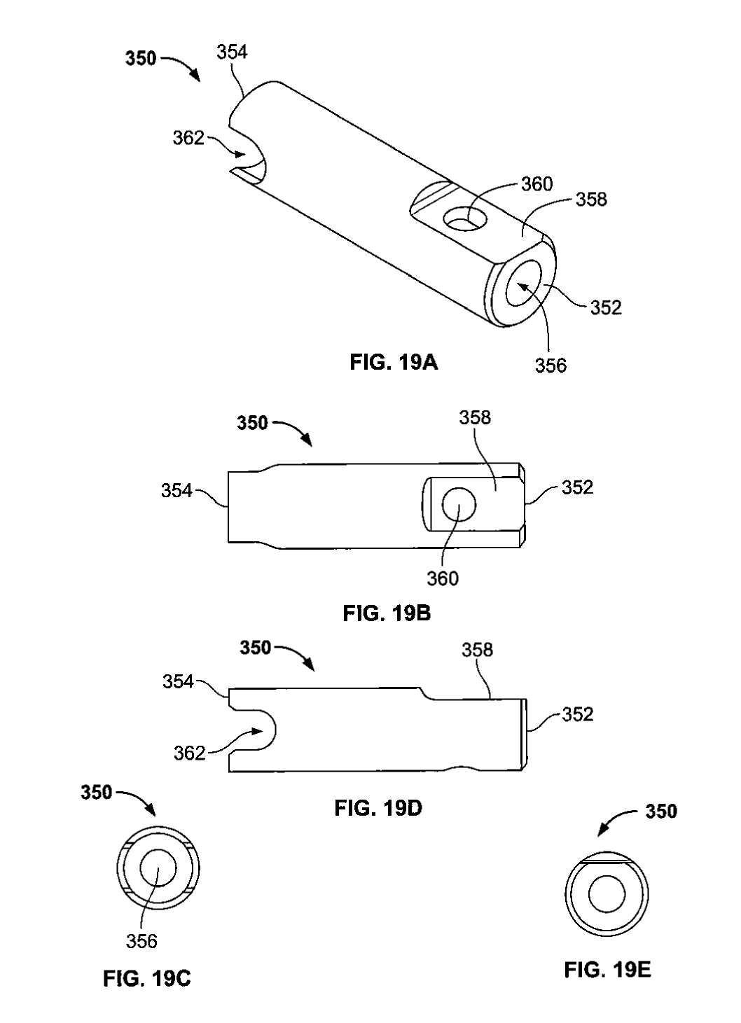

Referring to FIGS. 12 and 19A through 19E, in an embodiment, a plunger mechanism 348 includes a cylindrical-shaped plunger 350 having a first end 352 and a second end 354 opposite the first end 352, an first aperture 356 extending axially from the first end 352 to the second end 354, a flat edge 358 formed proximate to the first end 352, a second aperture 360 formed transversely through the plunger 350 proximate to the second end 354 thereof, and a U-shaped slot 362 formed within the first end 352. In an embodiment, an interior 364 of the plunger 350 is sized and shaped to house a plunger spring 366 (i.e., a compression spring), one end of which engages a rivet 368 that is inserted within the aperture 230b of the housing 212 (see FIG. 12). In an embodiment, a stop pin 370 is positioned within the second apertures 360 of the plunger 350 (see FIG. 12). As to be described in more detail below, in an embodiment, the plunger 350 is guided in the housing 212 and limited in axial travel by the stop pin 370, which engages and is guided in the central slot 256 of the housing 212.

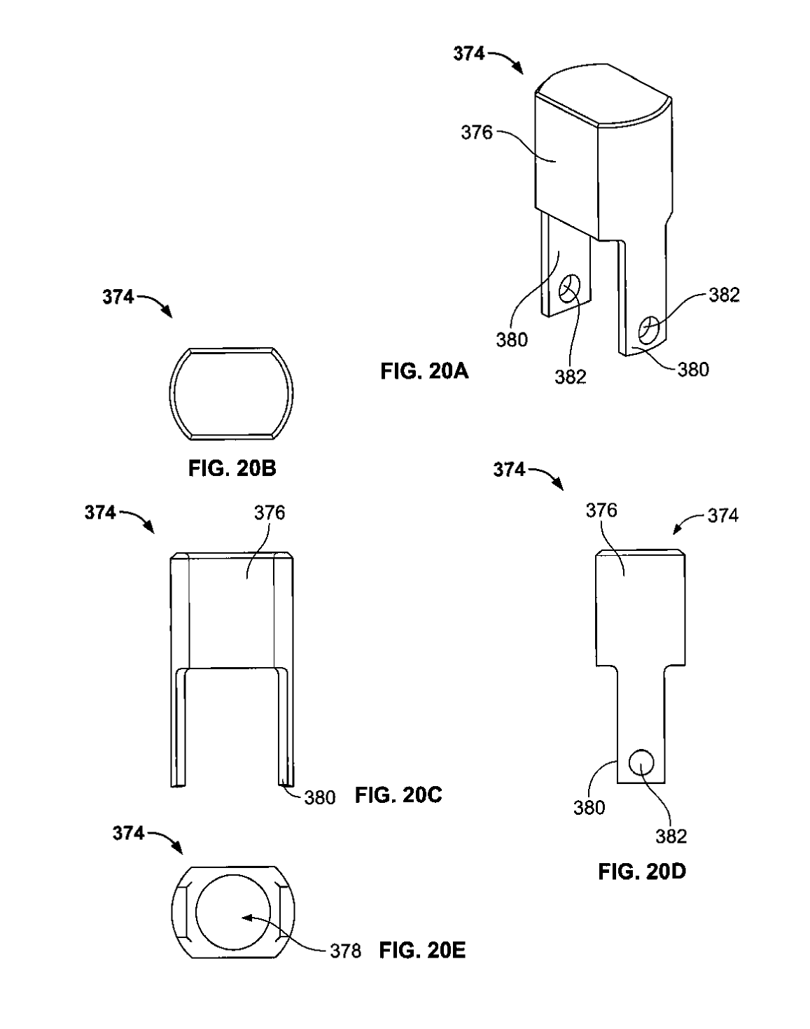

Referring to FIGS. 12 and 20A through 20E, in an embodiment, a button mechanism 372 includes a button 374 having a base 376 with a hollow interior portion 378 and a pair of legs 380 extending from the base 376, each of the legs 380 being parallel to one another. In an embodiment, each of the legs 380 includes an aperture 382 that is sized and shaped to receive a cross pin 384, which also extends through the slot 244 of the housing 212 (see FIG. 12). In an embodiment, a button spring 386 (i.e., compression spring) is nested within the interior portion 378 of the base 376 of the button 374 and against the housing 212 (see FIG. 12). As to be described in more detail below, in an embodiment, the button 374 is guided by a pair of rivets 388 inserted through the apertures 228 of the housing 312, and is limited in travel by the cross pin 384.

In an embodiment, the housing 212 and the handle 214 are fabricated from stainless steel, but other suitable materials can be used. In an embodiment, all other structural elements depicted in the Figures may also be fabricated from suitable grade stainless steel or other suitable alloy metal.

Referring to FIGS. 11 and 12, the pin latch 210 is shown in its closed position. While in the closed position, the handle 214 is retained within the channel 224 of the housing 212, with the exterior surface 274 of the handle 214 being flush or substantially flush with the upper end 220 of the housing 212. In an embodiment, the exterior surface 274 of the handle is flush or substantially flush with the exterior surface of the external structure to which the pin latch 210 is attached (not shown in the Figures). As shown in FIGS. 11 and 12, the shear pin 330 is in its fully extended position, i.e., the first end 332 of the shear pin 330 is positioned at a maximum distance from the housing 212. The shear pin 330 is sized and shaped to engage the external structure (not shown in the Figures). In an embodiment, the trigger 294 engages the trigger pins 283 such that trigger pins 283 engage the slots 304 of the detents 300. In an embodiment, the trigger 294 is spring-loaded via the trigger spring 306. In addition, in an embodiment, while the pin latch 210 is in its closed position, the interior surface 276 of the handle 214 engages the button 374 so that it is maintained in a depressed position, the button spring 386 is in a compressed position, and the cross pin 384 is disengaged from the shear pin 330. In an embodiment, the plunger 360 is set in an extended position, while the associated plunger spring 366 is in a relaxed state: that is, it is neither tensioned nor compressed.

Referring to FIGS. 15 and 16, in an embodiment, the pin latch 210 is opened to its intermediate position by pressing the trigger 294, wherein the tips 302 of the trigger 294 are released from the trigger pins 283 and the trigger pins 283 disengage the slots 304, freeing the handle 214 to rotate outwardly in direction D1 from the exterior surface of the structure. In an embodiment, when the trigger 294 is pushed, the handle 214 automatically and freely opens via the back spring 292. In an embodiment, when the handle 214 is rotated in this manner, the link 324 is pulled and, in turn, the shear pin 330 retracts into the housing 212. Simultaneously, in an embodiment, the button spring 386 expands, causing the button 374 to lift to a raised or elevated position. In addition, in an embodiment, the cross pin 384 travels within the slot 244 of the housing 212 and glides against the bottom edge 340 of the shear pin 330. In an embodiment, the cross pin 384 reaches and falls into the slot 342 of the shear pin 330 and travels within the slot 384 until it engages the stop 344. At this point, in an embodiment, retraction of the shear pin 330 stops and the pin latch 210 is set in its intermediate position.

Referring to FIGS. 21 and 22, in an embodiment, to further retract the shear pin 330, the button 374 is pushed (i.e., depressed) from its raised position in order to disengage the cross pin 384 from the slot 342 of the shear pin 330, and, simultaneously, the handle 214 is rotated further outward towards the open position in direction D1. During this sequence, in an embodiment, the link 324 further retracts the shear pin 330, and the second end 334 of the shear pin 330 pushes the first end 352 of the plunger 350 and compresses the plunger spring 366 until the second end 272 of the handle 214 engages the rivet 368 (see FIG. 22). In an embodiment, the stop pin 370 is urged to travel through the central slot 256 of the housing 212 until it stops against the end 257 of the central slot 256. At this point, in an embodiment, the handle 214 is in the open position and the shear pin 330 is fully retracted within the housing 212, as shown in FIGS. 21 and 22. In this open position, in an embodiment, the back spring 292 no longer provides a load in the handle 214, but the plunger spring 366 maintains a load thereon. In an embodiment, the slot 362 of the plunger 350 provides for clearance over the rivet 368. In this regard, in an embodiment, the handle 214 is manually held in the open position in order to maintain the shear pin 330 in its fully retracted position. In an embodiment, once the handle 214 is manually released, the pin latch 210 automatically returns to its intermediate position, as shown in FIGS. 15 and 16. In this regard, in an embodiment, the plunger spring 366 expands, causing the plunger 350 to push the shear pin 330 until the stop pin 370 stops against the second end 259 of the central slot 256 of the housing 212. In turn, the handle 214 rotates in direction D2. In an embodiment, the cross pin 384 then falls into the slot 342 of the shear pin 330, and the extension of the shear pin 330 stops in this intermediate position, as shown in FIGS. 15 and 16.

In an embodiment, in order to close the handle 214 from the intermediate position to the closed position, the handle 214 is rotated in direction D2 towards the closed position. In this regard, in an embodiment, the handle 214 pushes the link 324 to extract the shear pin 330 further, and the cross pin 384 glides on the bottom edge 340 of the shear pin 330 until the trigger 294 engages the trigger pins 283 and the handle 214 is retained within the channel 224 of the housing 212 (see FIGS. 21 and 22). The pin latch 210 is then latched in its closed position.

It will be understood that the embodiments described herein are merely exemplary and that a person skilled in the art may make many variations and modifications without departing from the spirit and scope of the invention. For instance, in certain embodiments, the pin latches 10, 210 may be used for doors and access panels for aircraft, such as fuselages, nacelles, engine cowlings, radomes, etc. In other embodiments, the pin latches 10, 210 can be used in other suitable environments and for other vehicles and structures. In other embodiments, each of the pin latches 10, 210 can be configured as a pin latch or other suitable latch, such as a hook latch. All such variations and modifications are intended to be included within the scope of the invention as defined in the appended claims.

What is claimed is:

1. A pin latch, comprising:
a housing having at least one pin;
a handle attached pivotally to the housing;
a shear pin housed slidably within the housing and connected to the handle;
and a finger member connected to the handle and to the housing, the finger member including at least one slot that is sized and shaped to receive slidably the at least one pin of the housing, the at least one slot including a first slot portion, a second slot portion, and a third slot portion that bridges the first and second slot portions with one another, the third slot portion forming a stop located between the first and second slot portions,
wherein the handle is moveable between a closed position, in which the handle is retained releasably within the housing and the shear pin is extended from the housing, and an open position, in which the handle is retracted from the housing and the shear pin is retracted within the housing,
wherein the handle is further moveable to an intermediate position, in which the handle is retained releasably in a position between its closed position and its open position, such that when the handle is moved from its closed position to its intermediate position, the at least one pin of the housing travels within the first slot portion of the finger member and engages the stop of the finger member in order to retain releasably the handle in its intermediate position, and
wherein the finger member is moveable from an engaged position, in which the at least one pin of the housing engages the stop of the finger member, and a disengaged position, in which the at least one pin of the housing is disengaged from the stop and is adapted to travel within the second slot portion of the finger member so as to enable the handle to be moved from its intermediate position to its open position.

2. The pin latch of claim 1, wherein the finger member includes at least one side member having a first end and a second end opposite the first end, and wherein the at least one slot of the finger member is formed within the at least one side member.

3. The pin latch of claim 2, wherein the at least one side member of the finger member includes a pair of side members, and the at least one pin of the housing includes a pair of pins, and wherein the slot of one of the side members is sized and shaped to receive slidably one of the pins of the housing, and the slot of the other of the side members is sized and shaped to receive slidably the other of the pins of the housing.

4. The pin latch of claim 3, wherein the finger member includes a grasping member that bridges the pair of side members, and wherein the grasping member facilitates the movement of the finger member from its engaged position to its disengaged position.

5. The pin latch of claim 4, wherein the first slot portion of the slot of one of the side members of the finger member is formed parallel to the second slot portion thereof, and the first slot portion of the other of the side members of the finger member is formed parallel to the second slot portion thereof.

6. The pin latch of claim 5, wherein the third slot portion of the slot of one of the side members of the finger member is positioned obliquely relative to the first and second slot portions thereof, and the third slot portion of the slot of the other of the side members of the finger member is positioned obliquely relative to the first and second slot portions thereof.

7. The pin latch of claim 6, further comprising a link having a first end and a second end opposite the first end of the link, the first end of the link being attached pivotally to the handle and the second end of the link being attached to the shear pin.

8. The pin latch of claim 7, wherein the handle includes a trigger that is releasably engageable with the pins of the housing when the handle is in its closed position.

9. The pin latch of claim 8, wherein the handle includes a block, wherein the first end of the link is attached pivotally to the block and the first ends of the side members of the finger members are attached pivotally to the block.

10. The pin latch of claim 8, wherein the handle includes a back spring.

11. The pin latch of claim 10, further comprising at least one finger extension spring having a first end connected to one of the side members of the finger member and a second end opposite the first end of the at least one finger extension spring connected to the link.

12. The pin latch of claim 11, wherein the at least one finger extension spring includes a pair of finger extension springs, one of which is connected to one of the pair of side members and to the link, and the other of which is connected to the other of the pair of side members and to the link.

13. The pin latch of claim 1, wherein the housing includes a first end, a second end opposite the first end of the housing, and an aperture formed within the first end of the housing, and wherein the shear pin is sized and shaped to slide within the aperture.

14. The pin latch of claim 1, wherein the housing includes at least one mounting bracket.

15. A pin latch, comprising:
a housing;
a handle attached pivotally to the housing;
a shear pin housed slidably within the housing and connected to the handle, the shear pin including a slot and a stop located at one end of the slot; and
a button mechanism including a cross-pin,
wherein the handle is moveable between a closed position, in which the handle is retained releasably within the housing, and an open position, in which the handle is retracted from the housing and the shear pin is retracted within the housing,
wherein when the handle is in its closed position, the shear pin extends from the housing, and the button mechanism is in a depressed position such that the cross-pin of the button mechanism is disengaged from the slot of the shear pin,
wherein the handle is further moveable to an intermediate position, in which the handle is retained releasably in a position between its closed position and its open position, wherein when the handle is moved from its closed position to its intermediate position, the button mechanism is moved from its depressed position to a raised position, and the shear pin retracts into the housing such that the cross-pin of the button mechanism engages the slot of the shear pin and glides therein until the cross-pin engages the stop of the shear pin.

16. The pin latch of claim 15, wherein the handle is moveable from its intermediate position to its closed position by depressing the button mechanism into its depressed position so as to disengage the cross-pin of the button mechanism from the slot of the shear pin.

17. The pin latch of claim 16, further comprising a link having a first end and a second end opposite the first end of the link, the first end of the link being attached pivotally to the handle and the second end of the link being attached to the shear pin.

18. The pin latch of claim 17, wherein the housing includes at least one trigger pin and the handle includes a trigger that is releasably engageable with the at least one trigger pin of the housing when the handle is in its closed position.

19. The pin latch of claim 18, wherein the handle includes a block, wherein the first end of the link is attached pivotally to the block.

20. The pin latch of claim 18, wherein the handle includes a back spring.

21. The pin latch of claim 20, wherein the housing includes a first end, a second end opposite the first end of the housing, an upper end, a lower end, and a first slot positioned proximate to the lower end, wherein the cross-pin of the button mechanism is housed movably within the first slot, and wherein the cross-pin travels within the slot when the button mechanism is moved between its depressed position and its raised position.

22. The pin latch of claim 21, wherein the button mechanism includes a spring to facilitate movement of the button mechanism from its depressed position to its raised position.

23. The pin latch of claim 22, wherein the handle engages the button mechanism and maintains it in its depressed position when the handle is in its closed position.

24. The pin latch of claim 23, further comprising a plunger mechanism housed within the housing, the plunger mechanism including a plunger having a first end, a second end opposite the first end of the plunger, an interior portion extending from the second end of the plunger, a stop pin positioned proximate to the first end of the plunger, and a spring housed within the interior portion of the plunger, and wherein the housing includes a second slot extending longitudinally between the first and second ends of the housing and including a first end and a second end opposite the first end of the second slot, wherein the stop pin of the plunger is sized and shaped to engage and travel within the second slot of the housing.

25. The pin latch of claim 24, wherein when the handle is moved from its intermediate position to its open position, the second end of the shear pin urges the plunger towards the second end of the housing and the stop pin of the plunger to travel within the second slot of the housing until the stop pin stops at the second end of the second slot, and the spring of the plunger mechanism is maintained in a compressed state.

26. The pin latch of claim 25, wherein the handle is adapted to be manually held in its open position, and wherein when the handle is manually released, the spring of the plunger mechanism expands from its compressed state to an expanded state, thereby urging the plunger to extract the shear pin until the stop pin stops against the first end of the second slot of the housing, and the cross-pin engages the slot of the shear pin.

27. The pin latch of claim 21, wherein the housing includes an aperture formed within the first end of the housing, and wherein the shear pin is sized and shaped to slide within the aperture.

28. The pin latch of claim 1, wherein the housing includes at least one mounting bracket.
